(19) United States
(12) Patent Application Publication
(10) Pub. No.: US 2018/0204672 A1
(43) Pub. Date: Jul. 19, 2018

(54) HIGH Q ADJACENT PRINTED ANTENNA FOR WIRELESS ENERGY TRANSFER

(71) Applicant: ARRIS Enterprises LLC, Suwanee, GA (US)

(72) Inventor: Sergio Alfredo Mendoza Aguirre, Escobedo (MX)

(21) Appl. No.: 15/405,761

(22) Filed: Jan. 13, 2017

(51) Int. Cl. H01F 38/14; H01F 41/04; H01F 27/28; H01Q 1/36; H01Q 1/38; H01Q 7/00; H02J 50/10

(52) U.S. Cl. CPC H01F 38/14; H01F 41/041; H01F 27/2804; H02J 50/10; H01Q 1/38; H01Q 7/00; H01Q 1/364

(57) ABSTRACT

An inductive coil or High Q antenna apparatus, method and computer readable media for a wireless system comprises two or more adjacent conductor traces on a substrate. The two or more adjacent conductor traces are arranged parallel to each other and electrically connected at proximal and distal ends. The two or more adjacent conductor traces are displaced from each other by a preselected fixed distance and are arranged in a single layer on one side of the substrate. Advantageously, the two or more adjacent conductor traces effectively reduce the Effective Series Resistance (ESR) and have the effect of improving the Quality Factor Q of the inductive coil enabling data transmission over large distances.

### 1. FIELD OF THE INVENTION

The present invention relates to inductive coils and High Q printed antennas; and, more particularly, to a multi-trace single layer printed wiring board High Q antenna coil or an inductive coil formed from two or more adjacent parallel traces reducing the Effective Series Resistance (or Equivalent Series Resistance or ESR) and increasing the quality factor.

### 2. BACKGROUND

Wireless energy encompasses non-radiative and radiative technologies. Radiative far-field techniques, or power beaming, involves capacitive coupling between metal electrodes for electric field energy transfer by way of beams of electromagnetic radiation transferred to a receiver. Transport of energy can be carried out over longer distances, however it requires in line transfer with the receiver. Non-radiative technologies involve power transfer by magnetic fields through inductive coupling between coils made by wound magnet wire and printed coils to generate the magnetic field.

Transfer Efficiency depends on Effective Series Resistance (ESR) on the coil employed. Reduction of ESR increases the Quality Factor (Q factor) on the transfer/receiving coil. Wireless networking technology, including Wireless Fidelity (Wi-Fi) and Worldwide interoperability for Microwave Access (WiMAX), require energy transfer technology that supports large scale networking with high data speeds over long distances. Q factor is an ever important feature sought in wireless networking technology industries. Problems have been encountered in effectively reducing ESR to increase Q factor as related in energy and data transfer. Currently, vertical interconnect access (via) electrical connection is utilized to extend conductivity through the plane of one or more adjacent layers. Vias consist of two pads in corresponding positions on different layers of the board electrically connected by a hole through the board, thus involving connecting inner trace layers in attempts to reduce ESR. Traditionally, to increase energy transfer, thick coils of wound enameled wires are used over layers of boars, resulting in increase in overall size and inefficient housing with inefficient transfer capabilities.

There exists a need in the art for a printed circuit board that avoids vias and eliminates wound enameled wires on transmitter coils while effectively reducing ESR and increasing Q factor. Further, there is a need in the art for a high Q printed wired board antenna adapted for use in cable-modems, nodes, amplifiers, and set-top boxes that is capable of transmitting and receiving signals from a long distance in WiMAX and/or Wi-Fi formats.

### SUMMARY OF THE INVENTION

The present invention uses printed coils as a mean to make a transmitter/receiver coil with improved Effective Series Resistance (ESR). This is accomplished by placing adjacent traces, in any pattern configuration. In essence more than one adjacent traces are required to reduce ESR. This has the effect of improving the Quality Factor of the Coil being used based on the following formulation: Q=w*L/ESR. The present invention provides an inductive coil and/or antenna for a wireless system that can transmit and receive signals over a long distance in wireless data transfer technologies, including WiMAX and/or Wi-Fi.

In a first aspect of the invention an inductive coil apparatus for a wireless system is provided. The inductive coil comprises two or more adjacent conductor traces arranged parallel to each other and electrically connected at proximal and distal ends. The two or more adjacent conductor traces being displaced from each other by a preselected fixed distance and are arranged in a single layer on one side of a substrate. The two or more adjacent conductor traces reduce the Effective Series Resistance (ESR) and have the effect of improving the Quality Factor Q of the inductive coil.

In another aspect of the invention, the inductive coil's substrate comprises a dielectric insulating circuit board. The inductive coil if preferably formed so that the two or more adjacent conductor traces arranged parallel to each other have multiple bends to form a continuous single layer coil structure on a single plane of the substrate. The reciprocal of the ESR of the inductive coil is equal to the sum of reciprocal of the resistance of each of the two or more adjacent conductor traces arranged parallel to each other. Inductance of the inductive coil is proportional to the square of the number of adjacent conductor traces arranged parallel to each other. Quality factor of the inductive coil is equal to circular frequency times inductance divided by the ESR.

In another aspect of the invention, there is provided a method of manufacturing an inductive coil for a wireless system, comprising the steps of: selecting a substrate comprising an insulating dielectric board; applying and bonding electro deposited high purity electrodeposited thin copper foil; applying a photoresist and UV exposing the antenna pattern and hardening the photoresist; washing off the unexposed portion of photoresist, exposing copper surface; acid etching copper to create two or mom adjacent conductor traces arranged parallel to each other, the two or more adjacent conductor traces being displaced from each other by a preselected fixed distance and being arranged in a single layer on one side of the substrate; connecting the two or more adjacent conductor traces at proximal and distal ends to an electrical connection pad; and protecting the surface of the two or more adjacent conductor traces with a polymeric protective coating; wherein the two or more adjacent conductor traces reduces the Effective Series Resistance (ESR) and has the effect of improving the Quality Factor Q of the inductive coil; and whereby the two or more adjacent conductor traces have thickness determined by the thickness of the copper foil used and have a precise length and width and are spaced by designed dimension.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1 illustrates an embodiment of the antenna is powered by input power connected to a signal generator of an amplifier;

FIG. 2a is a schematic illustration of an embodiment of the high Q antenna;

FIG. 2b is a cross-sectional view of the high Q antenna taken at X-X in FIG. 2a;

FIG. 3A illustrate a first antenna shape or inductive coil shape, wherein the shape is a circular antenna similar to the high Q antenna shown in FIG. 2;

FIG. 3B shows a second antenna shape or inductive coil shape, wherein the shape is a square grid;

FIG. 3C shows a third antenna shape or inductive coil shape, wherein the shape is an eight sided polygon;

FIG. 4A is an illustration of an embodiment of the inductive coil or High Q antenna wherein two conductor traces are used;

FIG. 4B is an illustration of an embodiment of the inductive coil or High Q antenna wherein three conductor traces are used;

FIG. 5 is a schematic illustration of the current in a transmission antenna coil as a function of quality factor Q;

FIG. 6A illustrates the high Q adjacent printed antenna used as a communication component in cable-modems;

FIG. 6B illustrates the high Q adjacent printed antenna used as a communication component in nodes;

FIG. 6C illustrates the high Q adjacent printed antenna used as a communication component in AP or set-top boxes;

FIG. 7 illustrates the steps involved informing the High Q adjacent printed antenna;

FIG. 8A illustrates a graph showing antenna power dissipation/dissipation factor (DF) in an example, Example #1, showing DF for a single trace wherein, trace width is increased;

FIG. 8B illustrates a graph showing antenna power dissipation/dissipation factor (DF) continuing with an example, Example #1, showing DF for traces N=1-5 parallel traces at trace width 5 mils.

### DETAILED DESCRIPTION OF THE INVENTION

The present invention provides an inductive coil and/or High Q antenna constructed having two or more adjacent conductor traces arranged parallel to one another on a single layer or single plane of a substrate, such as a printed wiring board (PWB). It is understood that the term plurality or multi or multiple used herein throughout means more than one. Conductor ESR is proportional to trace length. ESR is reduced when two (2) or more adjacent traces are connected in parallel. Use of single layer adjacent coils provides an antenna with improved transfer efficiency and Q Factor by reducing ESR. Printed Coils are utilized as a means to make a transmitter/receiver coil with improved effective series resistance (ESR). This is accomplished by placing adjacent traces, in any pattern configuration (i.e. coil, square, parallelogram, and the like). In essence more than one adjacent trace is required to reduce the Effective Series Resistance (ESR). This has the effect of Improving the Quality Factor Q of the inductive coil being used. Q=w*L/ESR, where w is circular frequency, L is the inductance of the coil.

Preferably, the two or more adjacent conductor traces each have a trace width (W) ranging from 5 mils to 20 mils with a Width, Spacing (S) ratio preferable in the range of 0.33<W/S<2. The two or more adjacent conductor traces preferably have a trace width ranging front 5 to 20 mils, and wherein a Q factor ranging from 4.8 to 15.5.

In another aspect of the invention, three adjacent conductor traces are provided running in parallel, wherein each of said conductor traces have a trace width ranging from 5 to 20 mils, and wherein said inductive coil has a Q factor ranging from 14.4 to 46.65. In yet another aspect of the invention, four adjacent conductor traces are provided running in parallel, wherein each of said conductor traces have a trace width ranging from 5 to 20 mils, and wherein said inductive coil has a Q factor ranging from 38.5 to 124.41.

The two or more adjacent conductor traces preferably reduce the Effective Series Resistance (ESR) by a factor of an inverse of number of adjacent coils 1/N. This has the effect of improving the Quality Factor Q of the inductive coil being used by ESR*1/N because Q=w*L/ESR, where w is circular frequency, L is the inductance of the coil.

Preferably, the inductive coil for a wireless system has an antenna dissipation power/factor (DF) improved by a factor of an inverse of number of adjacent coils 1/N. It is noted that ESR is responsible for the energy dissipated as heat and it is directly proportional to the DF. Therefore wherein ESR is reduces by 1/N, DF is proportionally reduced.

In a first aspect of the invention an inductive coil apparatus for a wireless system is provided. The inductive coil comprises two or more adjacent conductor traces arranged parallel to each other and electrically connected at proximal and distal ends. The two or more adjacent conductor traces being displaced from each other by a preselected fixed distance and are arranged in a single layer on one side of a substrate. The two or more adjacent conductor traces reduce the Effective Series Resistance (ESR) and have the effect of improving the Quality Factor Q of the inductive coil.

The subject High Q antenna or inductive coil comprises multiple, two or more, parallel conductor traces connected as a parallel circuit printed on a printed wired board. The high Q of the antenna resonates at a sharp frequency with high current magnitude, enabling transmission of signals or receipt of weak signals from long distances. The high Q of the antenna coil arises from the parallel connection of several individual conductor traces, resulting in reduced series effective resistance. The inductance of the parallel spaced multiple coil is increased according to the square of the number of individual conductor traces. The quality factor of the high Q antenna coil is the product of the circular frequency and the inductance of the antenna coil divided by the series effective resistance (which can be very high), enabling data transmission over large distances.

In another aspect of the invention, the inductive coil's substrate comprises a dielectric insulating circuit board. The inductive coil if preferably formed so that the two or more adjacent conductor traces arranged parallel to each other have multiple bends to form a continuous single layer coil structure on a single plane of the substrate. The reciprocal of the ESR of the inductive coil is equal to the sum of reciprocal of the resistance of each of the two or more adjacent conductor traces arranged parallel to each other. Inductance of the inductive coil is proportional to the square of the number of adjacent conductor traces arranged parallel to each other. Quality factor of the inductive coil is equal to circular frequency times inductance divided by the ESR.

Another aspect of the invention provides an inductive coil formed via a powered high Q printed wired board antenna is provided that has a plurality of adjacent flat thin conductor traces with a rectangular cross section positioned parallel to each other and connected at each end to a pad or substrate. The conductor traces are arranged in a parallel adjacent connection, significantly decreasing the effective series resistance of the high Q antenna. With this arrangement, the number of turns of the antenna creates a magnetic field adding inductance to a circuit forming an inductor with an inductance value, L that is proportional to the square of the number of multiple conductor traces. The Q value of the antenna is equal to the circular frequency times the coil inductance divided by the effective series resistance. Accordingly use of two parallel conductor traces results in a Q value that is about (2²/0.5) or 4 times the Q value of a single coil antenna. Use of three parallel conductor traces results in Q value that is about (3²/0.33) or 27 times the Q value of a single coil antenna. This high value of Q allows signal transmission over longer distances as well as receipt of weak signals for amplification from distant signal sources. The high Q adjacent printed antenna may be used as a component in a wireless charging system. In addition, the high Q adjacent printed antenna may be used as a component in a system for wireless data transfer at frequencies covering and extending Wi-Fi and Wi-Max ranges.

Preferably the two or more adjacent conductor traces etched out of wide sheets of conductors made from copper, gold or silver sheets with a limited thickness and long lengths. High frequency currents generally flow on the surface of thick conductors due to skin effect increasing the resistance. Skin effect is a phenomena wherein alternating electric current (AC) is predominantly distributed near the surface of a conductor so that the density is largest at the surface, while diminishing at greater depths in the conductor. Thus, the electric current flows mainly at the “skin” of the conductor, between the outer surface and a level called the skin depth. Effective resistance of the conductor increases at higher frequencies where the skin depth is smaller because of the skin effect, thereby reducing the effective cross-section of the conductor. However, if the conductors are very thin there is no skin effect and current essentially flows through the entire thickness of the thin conductor and does not increase the resistance of conductors due to skin effect.

The rigid polymeric strip for the printed wired board antenna may be made from a number of polymeric materials as well as other materials or substrates. One common choice is glass filled polymers such as, FR-4, glass filled epoxy sheets. Others suitable polymeric materials comprise N7000-Polyimide Park-Nelco, CLTE Arlon, RT6010LM Rogers, RO4350B Rogers and RT6002 Rogers. Since the polymeric sheet is bathed in the radiating field of the antenna, it imparts capacitance and affects the Q value. Therefore, proper design, of the polymeric strip is essential to produce high Q values.

Any suitable technique for printing circuit boards can be used to make the printed coils. For non-limiting example, printed coils can be formed by depositing copper on a substrate to form traces in the shape of coils or selectively etching copper from a substrate to form traces in the shape of coils. Generally, the high Q adjacent printed antenna for wireless energy may be formed or etched on an electroplated high conductivity copper sheet bonded to a polymeric sheet. The copper sheet may be coated with a photoresist polymer that hardens when exposed to UV. A pattern of the conductor is exposed to define the antenna structure which may have two or more parallel strips with uniform spacing defining the antenna shape. The unexposed portion of the UV sensitive polymer is washed off exposing the copper sheet, which is then etched by an acid bath, leaving behind the precise shape of the antenna structure. The conductors may be coated with a protective coating. The two or three sets of parallel conductors are connected to each other at each end of the conductor trace. Accordingly, the resistance of the two or more parallel conductors connected in parallel is significantly reduced as compared to a single conductor antenna coil.

In a preferred aspect of the invention, the high Q adjacent printed antenna or inductive coil for wireless energy system of the present invention, comprises a dielectric insulating circuit board with a bonded thin sheet of conductive copper sheet etched to define an antenna. The inductive coil or antenna is applied to one side of the dielectric insulating board in a single layer avoiding the need for multiple layers or planes through vias. Multiple parallel conductor traces are provided as two or more adjacent conductor traces are displaced from each other by a preselected fixed distance, adapted to reduce capacitance effects at high transmitting or receiving frequencies of the antenna. Reciprocal of the effective series resistance of the antenna is equal to the sum of the reciprocal of the resistance of each of the multiple parallel conductor traces that are connected in parallel on the same plane. The inductance of the antenna is proportional to the square of the number of parallel traces. Q factor of the antenna is equal to the circular frequency times the inductance divided by the effective series resistance.

With this arrangement, a two parallel coil antenna has eight (8) times the Q factor of a single coil; and a three parallel coil antenna has twenty seven (27) times the Q factor of a single coil. The high Q antenna of the present invention has much larger Q factor as compared to single coil antennas and therefore can transmit data signals over distances between transmitter and receiver antennas ranging up to 300 ft. radius (in home networking Wi-Fi routers operating on the traditional 2.4 GHz band, for example).

The method for manufacturing the inductive coil or high Q antenna comprises the steps of: comprising the steps of: (a) selecting a substrate comprising an insulating dielectric board; (b) applying and bonding electro deposited high purity electrodeposited thin copper foil; (c) applying a photoresist and UV exposing the antenna pattern and hardening the photoresist; (d) washing off the unexposed portion of photoresist, exposing copper surface; acid etching copper to create two or more adjacent conductor traces arranged parallel to each other, the two or more adjacent conductor traces being displaced from each other by a preselected fixed distance and being arranged in a single layer on one side of the substrate; (e) connecting the two or more adjacent conductor traces at proximal and distal ends to an electrical connection pad; and (f) protecting the surface of the two or more adjacent conductor traces with a polymeric protective coating. The two or more adjacent conductor traces reduce the Effective Series Resistance (ESR) and have the effect of improving the Quality Factor Q of the inductive coil. Whereby the two or more adjacent conductor traces have thickness determined by the thickness of the copper foil used and have a precise length and width and are spaced by designed dimension. High Q antennas manufactured in accordance with the aforementioned method exhibit multiple parallel conductor traces that have thickness determined by the thickness of the copper foil used. These antennas also have a precise length and width, and are spaced by designed dimensions.

The invention provides a high Q antenna that is on a single board with no interconnecting vias. Due to the close spacing of parallel traces of conductors, the capacitance effects that reduce the Q value of the antenna are reduced. Since the conductors are very thin traces formed from an electrodeposited copper sheet, the skin effect is extremely small and current supplied by the amplifier passes through the cross-section of the conductor rather than the surface or skin depth, averting typical problems associated with high frequency current transmission that leads to an increase in conductor resistance or a decrease in the Q of the coil.

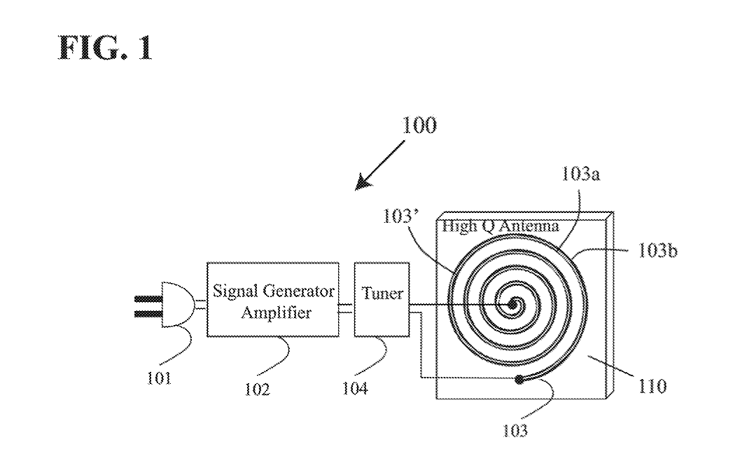

FIG. 1 illustrates a transceiver shown generally at 100 including an embodiment of the subject inductive coil or antenna powered by input power 101 connected to a signal generator 102 of an amplifier through a high Q antenna 103. Antenna 103 or inductive coil is formed of two or more adjacent conductor traces 103a, 103b, arranged parallel to each other have multiple bends 103′ to form a continuous single layer coil structure on a single plane of a substrate 110. Transceiver 100 comprises a transmitter and a receiver sharing common circuitry in a single housing, such as a wireless access point (WAP/AP), a networking hardware device that allows Wi-Fi compliant devices to connect to a wired network, and/or a set-top box (STB) or set-top unit (STU). Antenna 103 is contained within housing of the transceiver 100 configured herein as an AP, however, it is understood to those in the art that the subject antenna configuration may also be used in other types of electronic devices such as, for non-limiting example, in printed WiMAX, Wi-Fi Antennas on Cable-Modems, Nodes, Amplifiers, Set-top boxes, and technology implementing wireless energy transfer on portable devices.

The wall plug provides the electrical power needed to drive the signal generator and amplifier and pass current through the high Q antenna 103. The transceiver 100 or AP is configured to send communications or data signal transmissions, and receive communications from one or more networks (e.g., WAN, local network, cloud, headend/cloud controller, and the like). The amplifier and the high Q antenna form a tuned circuit that drives the antenna at a very specific frequency enabling data signal transmission over large distances. A tuner 104 is provided between the amplifier and the antenna to bring the frequency to the resonant value. This tuned antenna is a part of a network which transmits and receives data to and from other components. When the antenna is used to receive a weak data signal, the tuned antenna is ready to receive the signal due to high Q of the antenna and the amplifier amplifies the signal data. When the antenna is used to transmit a data signal, the tuned antenna is ready to transmit the signal over larger distances (i.e. distances greater than 300 ft radius (in home networking Wi-Fi routers operating on the traditional 2.4 GHz band, for example)) due to high Q of the antenna and the amplifier that amplifies the data signal. The portion of this circuit is not shown.

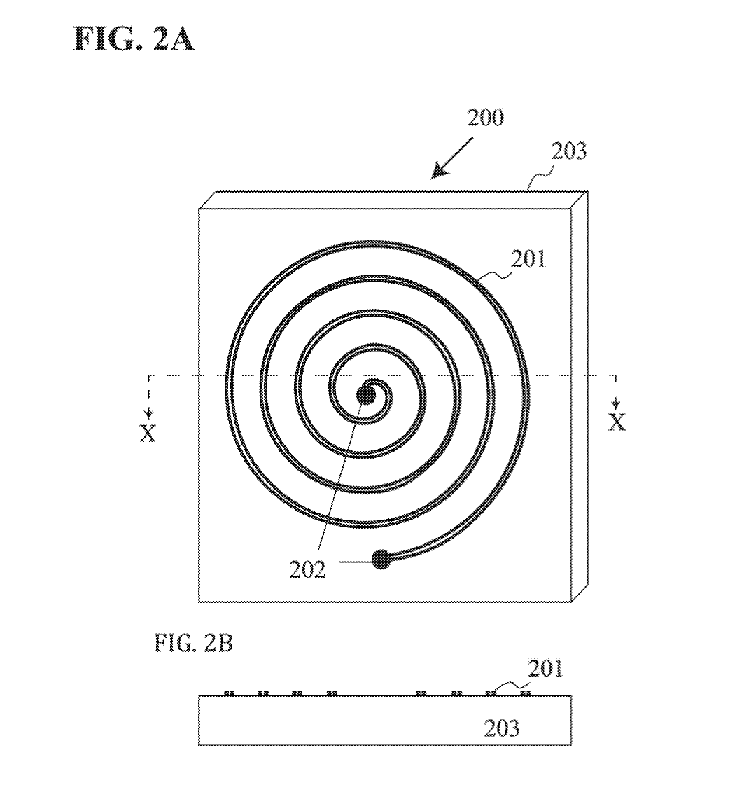

FIG. 2a illustrates at 200 another embodiment of the inductive coil or high Q antenna. In the embodiment shown, the inductive coil or high Q antenna has an insulating circuit board 203 that carries a spiral multi conductor 201 printed on one side of the insulating board. In this FIG. there are two individual thin, wide long length conductor elements fabricated from etching of photolithography pattern. The two conductor traces are parallel to each other and are closely spaced as shown. The two conductor traces are joined together at each end on two pads 202, thus forming a parallel connection of the conductor traces. FIG. 2b illustrates the cross section at X-X of the high Q antenna of FIG. 2a. Insulating board 203 is shown with thin spiral multi conductor 201 present on the surface thereof.

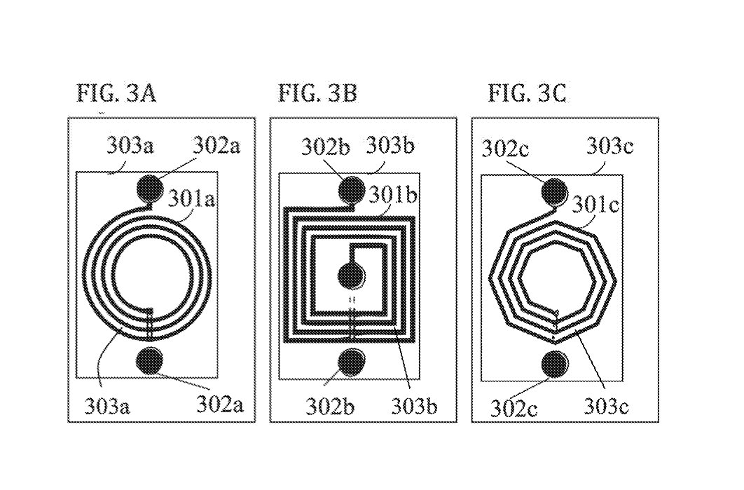

FIGS. 3A-3C illustrate alternate shapes of the antenna. FIG. 3A shows a first antenna shape, wherein the shape is a circular antenna similar to the high Q antenna shown in FIG. 2. FIG. 3B shows a second antenna shape, wherein the shape is a square grid. FIG. 3C shows a third antenna shape, wherein the shape is an eight sided polygon. In each of FIGS. 3A-3B the insulating board is shown at 303a, 303b, and 303c, respectively, while 301a, 301b and 301c represent the multiple conductor trace (shown here as a single line for clarity) and 302a, 302b, and 302c represent end pads connected to each end of the antenna coil. Multiple conductor trace (shown herein as a single line for clarity) 302a, 302b and 302c are formed having at least two-conductor traces forming adjacent parallel traces. Alternatively, at least three-conductor traces forming adjacent parallel traces are provided. The multiple conductor traces are preferably configured as single traces separated apart by about 0.5 to 3.0 times the width of a single conductor trace, and more preferably by about 1.5 to 3.0 times the width of a single conductor trace. In turn, the width of a single conductor trace preferably ranges from 0.01 mm to 0.25 mm, providing very thin conductor traces so that there is no skin effect, and therefore no increased resistance, so that the current flows through the entire thickness of the conductors. Separation between the coils, as shown at 303a, 303b and 303c, preferably ranges from 1.5 to 3.00 times the width of a single conductor trace.

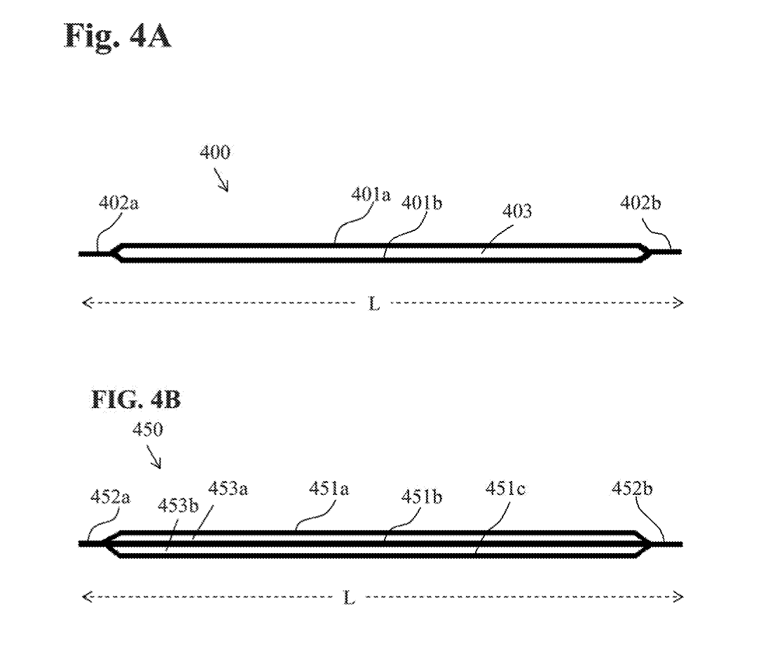

FIGS. 4A and 4B illustrate embodiments of conductor traces. FIG. 4A illustrates, at 400, a two-conductor trace formed by conductor traces 401a and 401b joined together at the proximal and distal ends by connection pads 402a, 402b. The length of the conductor trace 400 is shown at L. Conductor ESR is proportional to trace length: ESR=(p*L)/A, where L is length and A is cross sectional area of conductive trace. Thus, ESR is reduced when two (2) or more adjacent traces are connected in parallel. FIG. 4B illustrates, at 450, a three-conductor trace formed by conductor traces 451a, 451b, and 451c joined together at proximal and distal ends by connecting pads 452a, 452b. In both cases, the multiple conductor parallel traces are spaced apart by about 1.5 to 3 the width of a single conductor trace, as shown at 403 in FIG. 4A and at 453a and 453b in FIG. 4B. The two or three conductor traces are joined together both at the proximal and distal end of the conductor. The length of the conductor trace is shown at L. In FIGS. 2 and 3 these parallel multiple conductor traces are connected to connection pads.

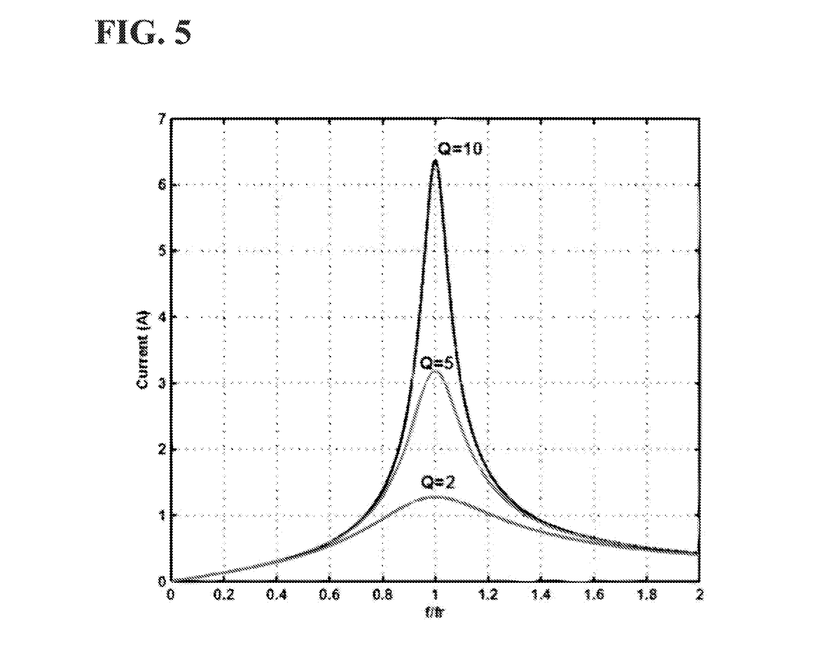

FIG. 5 illustrates graphically, the current flowing through the antenna that is tuned to a resonant frequency. The Q factor of the antenna coil determines the resonance peak of the antenna and its development as a function of frequency. The horizontal axis of the graph is f/fr where f is the frequency generated by the amplifier and fr is the resonance frequency. At low values of Q, for example Q of 2, the peak extends over a large frequency range and the peak current in the antenna coil is depressed. When Q is high, for example a Q value of 10, the resonance peak is sharp with limited spread of frequency from the resonance frequency and the current passing through the antenna coil is correspondingly increased. The increased current allows the antenna to communicate over larger distances. In order to excite the high Q antenna, the amplifier frequency has to be controlled and maintained and this is done by the tuning circuit shown in FIG. 1.

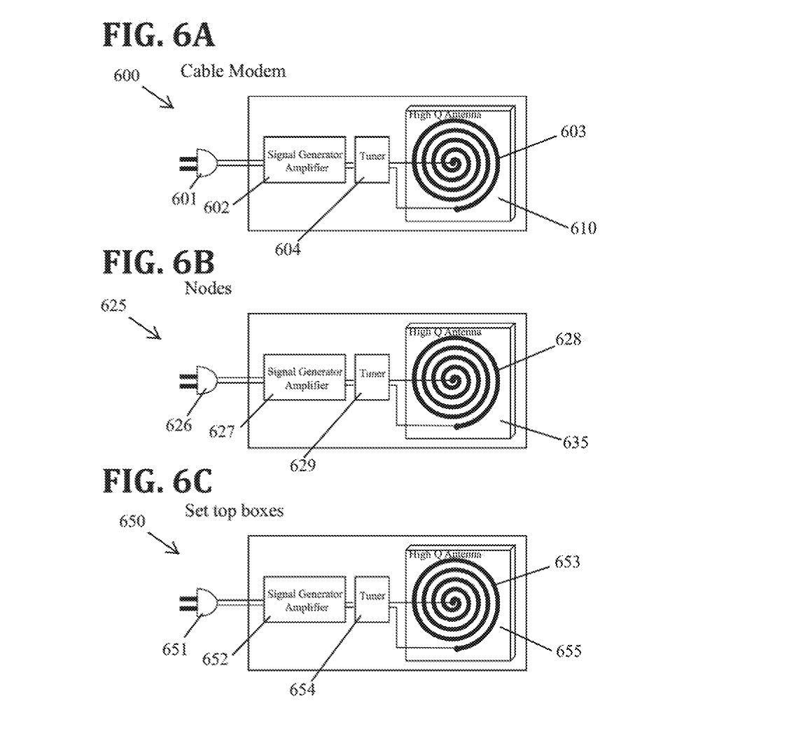

FIG. 6 illustrates the high Q adjacent printed antenna used as a communication component in cable-modems, nodes, amplifiers or set-top boxes. The high Q antenna is embedded within the device. The details of the device are not shown.

FIG. 6A illustrates a high Q adjacent printed antenna used in a transceiver as a communication component in cables-modems, shown, generally at 600. Transceiver 600 includes an embodiment of the subject inductive coil or antenna powered by input power 601 connected to a signal generator 602 of an amplifier through a high Q antenna 603. Antenna 603, or inductive coil, is formed of two or more adjacent conductor traces arranged parallel to each other have multiple bends to form a continuous single layer coil structure on a single plane of a substrate 610, as discussed herein in relation to FIGS. 1-4B. Transceiver 600 comprises a transmitter and a receiver sharing common circuitry in a single housing. A tuner 604 is provided between the amplifier and the antenna to bring the frequency to the resonant value.

FIG. 6B illustrates the high Q adjacent printed antenna used as a communication component in nodes, shown generally at 625. Transceiver 625 includes an embodiment of the subject inductive coil or antenna powered by input power 626 connected to a signal generator 627 of an amplifier through a high Q antenna 628 formed of two or more adjacent conductor traces arranged parallel to each other have multiple bends to form a continuous single layer coil structure on a single plane of a substrate 635, as discussed herein in relation to FIGS. 1-4B. Transceiver 625 comprises a transmitter and a receiver sharing common circuitry in a single housing. A tuner 629 is provided between the amplifier and the antenna to bring the frequency to the resonant value.

FIG. 6C illustrates the high Q adjacent printed antenna used as a communication component in AP or set-top boxes, shown generally at 650. Transceiver 650 includes an embodiment of the subject inductive coil or antenna powered by input power 651 connected to a signal generator 652 of an amplifier through a high Q antenna 653 formed of two or more adjacent conductor traces arranged parallel to each other have multiple bends to form a continuous single layer coil structure on a single plane of a substrate 655, as discussed herein in relation to FIGS. 1-4B. Transceiver 650 comprises a transmitter and a receiver sharing common circuitry in a single housing. A tuner 654 is provided between the amplifier and the antenna to bring the frequency to the resonant value.

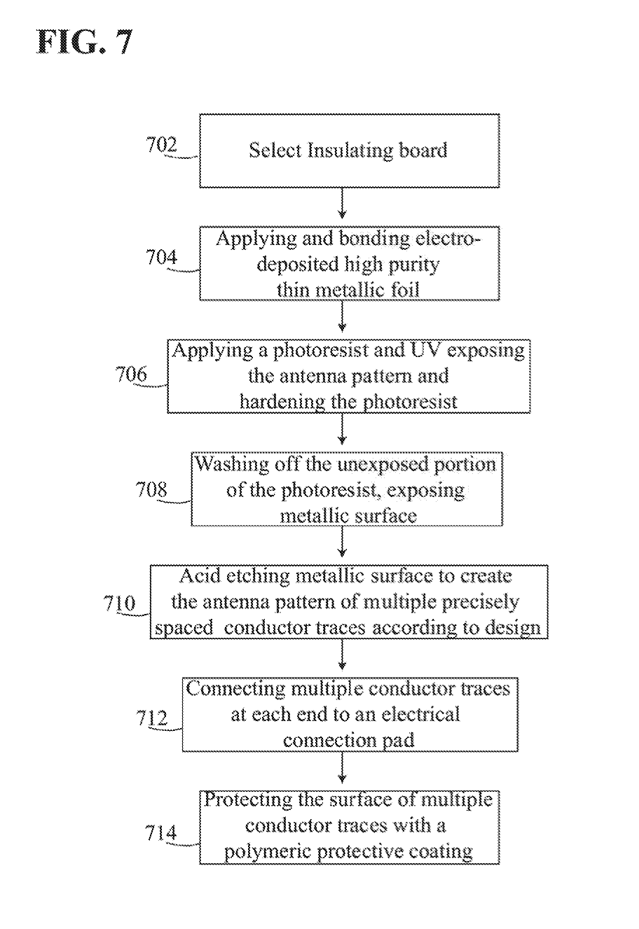

FIG. 7 illustrates the steps involved in forming the High Q adjacent printed antenna. As shown by FIG. 7, the High Q adjacent printed antenna is formed by a process comprising the steps of: selecting an insulating board, 702; applying and bonding electrodeposited high purity metallic foil, 704; applying a photoresist, and UV exposing the antenna pattern, and hardening the photoresist, 706; washing off the unexposed portion of the photoresist, exposing the metallic surface, 708; acid etching the metallic surface to create the antenna pattern of multiple, precisely spaced conductor tracings, according to design, 710; conducting multiple conductor tracings at each end to an electrical connection pad, 712; protecting the surface of the multiple conductor tracings with a polymeric coating, 714. The antenna pattern being the two or more adjacent conductor traces arranged parallel to one another.

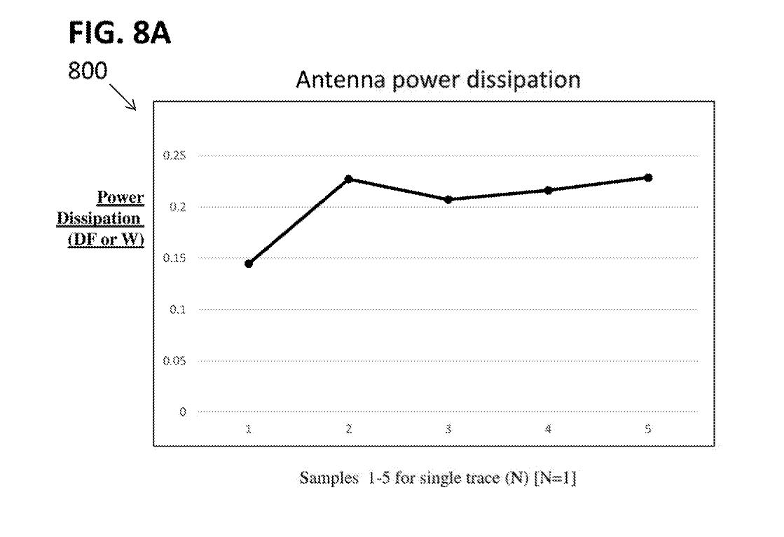

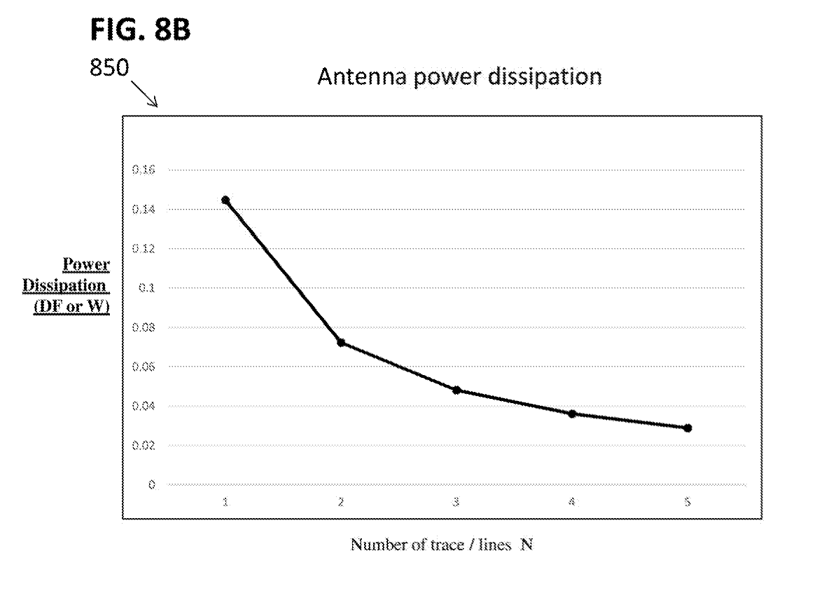

FIGS. 8A-8B illustrate graphs showing antenna power dissipation/dissipation factor (DF) in an Example #1, showing DF for a single trace wherein trace width is increased in FIG. 8A, and showing DF comparing single trace, two, three, four and five adjacent traces running parallel as a constant trace width [5 mils.] showing DF decreasing as a function of 1/N with increased adjacent traces running parallel. FIG. 8A illustrates a graph showing antenna power dissipation/dissipation factor (DF) in an example, Example #1, showing DF for a single trace wherein trace width is increased, shown generally at 800. The graph at 800 illustrates DF of samples 1-5 for a single trace (N=1) with trace width in mils, at current A, conductor resistance, and power dissipation as shown in Table 1 below.

TABLE 1

| Copper | trace | | Conductor | Power |
|---|---|---|---|---|
| weight | width | current | DC resistance | Dissipation |
| (oz) | (mils) | (A) | (Ohms) | (DF or W) |
| 1 | 5 | 1.0933 | 0.12108 | 0.14472 |
| 1 | 10 | 2.2608 | 0.04445 | 0.22719 |
| 1 | 15 | 2.7591 | 0.02722 | 0.20721 |
| 1 | 20 | 3.3193 | 0.01962 | 0.21613 |
| 1 | 25 | 3.8611 | 0.01533 | 0.22859 |
| 1 | 30 | 4.0779 | 0.01259 | 0.20929 |

Power dissipation (DF) was calculated as follows: DF=current (A) squared * conductor DC resistance. Value DF was extrapolated on graph 800. As the trace width (mils) increases, current (A) increases and conductor DC resistance (Ohms) decreases with Power Dissipation (DF) increasing at current (A) squared * conductor DC resistance. FIG. 8B illustrates a graph showing antenna power dissipation/dissipation factor (DF) continuing with an example. Example #1, showing DF for traces N−1-5 parallel traces at trace width 5 mils, shown generally at 850. The inductive coil for a wireless system has an antenna dissipation power/factor (DF) improved by a factor of an inverse of number of adjacent coils 1/N. ESR is responsible for the energy dissipated as heat, directly proportional to the DF. Therefore wherein ESR is reduces by 1/N, DF is proportionally reduced. Single trace DF*1/N wherein N equals the number of parallel traces is shown in graph 850 via corresponding Table 2 below at constant width 5 mils at row #2 of Table 2.

TABLE 2
Antenna Power Dissipation

| trace width | single | 2 lines in | 3 lines in | 4 lines in | 5 lines in |
|---|---|---|---|---|---|
| (mils) | Trace | parallel | parallel | parallel | parallel |
| 5 | 0.14472752 | 0.072363758 | 0.048242505 | 0.036181879 | 0.028945503 |
| 10 | 0.22719358 | 0.11359679 | 0.075731193 | 0.056798395 | 0.045438716 |
| 15 | 0.20721587 | 0.103607933 | 0.069071955 | 0.051803966 | 0.041443173 |
| 20 | 0.2161683 | 0.108084152 | 0.072056101 | 0.054042076 | 0.043233661 |
| 25 | 0.22854107 | 0.114270534 | 0.076180356 | 0.057135267 | 0.045708214 |
| 30 | 0.20936249 | 0.104681245 | 0.069787496 | 0.052340622 | 0.041872498 |

As shown in graph 850, at trace width 5 mils, as the number of adjacent traces running parallel (N or parallel traces) increases from single, two, three, four and five adjacent traces running parallel and the dissipation power (DF) decreases by value 1/N. Values for Example #1 are further shown below:

Example #1: Table 3—Q factor increases with increase in traces in parallel (N)

TABLE 3

| | | Q @1 MHZ | Q @1 MHZ | Q @1 MHZ | Q @1 MHZ | Q @1 MHZ |
|---|---|---|---|---|---|---|
| | | using a single | using 2 lines in | using 3 lines in | using 4 lines in | using 5 lines in |
| nH/in | pF/in | trace | parallel | parallel | parallel | parallel |
| 11.6005 | 1.7677 | 0.60167773 | 4.81342187 | 14.44026561 | 38.50737496 | 96.2684374 |
| 9.038 | 2.2689 | 1.27690979 | 10.21527829 | 30.64583487 | 81.72222632 | 204.3055658 |
| 7.3425 | 2.7928 | 1.69400808 | 13.55206466 | 40.65619398 | 108.4165173 | 271.0412932 |
| 6.0733 | 3.3764 | 1.94395127 | 15.55161019 | 46.65483058 | 124.4128815 | 311.0322039 |
| 5.0587 | 4.0537 | 2.07231807 | 16.57854455 | 49.73563366 | 132.6283564 | 331.5708911 |
| 4.2132 | 4.8671 | 2.1015803 | 16.81264241 | 50.43792724 | 134.5011393 | 336.2528483 |

Table 3 from Example #1 shows Q factor increasing with single trace, 2 adjacent traces running parallel, 3 lines in parallel, 4 lines in parallel and 5 lines in parallel. Q @ 1 MHZ increases significantly from single trace to 5 lines/traces in parallel as shown.

Table 4 from Example #1 below shows:

Example #1: Table 4—trace width W is shown relative to spacing S between adjacent traces running parallel [at width W 10 mils and width W 5 mils]

TABLE 4

| Width | Spacing | | Width | | |
|---|---|---|---|---|---|
| W | S | W/S | W | Spacing S | W/S |
| 10 | 4 | 2.5 | 5 | 5 | 1 |
| 10 | 5 | 2 | 5 | 6 | 0.833333 |
| 10 | 6 | 1.666667 | 5 | 7 | 0.714286 |
| 10 | 7 | 1.428571 | 5 | 8 | 0.625 |
| 10 | 8 | 1.25 | 5 | 9 | 0.555556 |
| 10 | 9 | 1.111111 | 5 | 10 | 0.5 |
| 10 | 10 | 1 | 5 | 11 | 0.454545 |
| 10 | 11 | 0.909091 | 5 | 12 | 0.416667 |
| 10 | 12 | 0.833333 | 5 | 13 | 0.384615 |
| 10 | 13 | 0.769231 | 5 | 14 | 0.357143 |
| 10 | 14 | 0.714286 | 5 | 15 | 0.333333 |
| 10 | 15 | 0.666667 | 5 | 16 | 0.3125 |
| 10 | 16 | 0.625 | 5 | 17 | 0.294118 |
| 10 | 17 | 0.588235 | 5 | 18 | 0.277778 |
| 10 | 18 | 0.555556 | 5 | 19 | 0.263158 |
| 10 | 19 | 0.526316 | 5 | 20 | 0.25 |
| 10 | 20 | 0.5 | 5 | 21 | 0.238095 |
| 10 | 21 | 0.47619 | 5 | 22 | 0.217273 |
| 10 | 22 | 0.454545 | 5 | 23 | 0.217391 |
| 10 | 23 | 0.434783 | 5 | 24 | 0.208333 |
| 10 | 24 | 0.416667 | 5 | 25 | 0.2 |
| 10 | 25 | 0.4 | 5 | 26 | 0.192308 |
| 10 | 26 | 0.384615 | 5 | 27 | 0.185185 |
| 10 | 27 | 0.37037 | 5 | 28 | 0.178571 |
| 10 | 28 | 0.357143 | 5 | 29 | 0.172414 |
| 10 | 29 | 0.344828 | 5 | 30 | 0.166667 |
| 10 | 30 | 0.333333 | 5 | 31 | 0.16129 |

Preferably, the two or more adjacent conductor traces each have a trace width (W) ranging from 5 mils to 20 mils with a Width to Spacing (S) ratio preferable in the range of 0.33<W/S<2. Table 4 above shows trace width (W) at 10 and 5 mils, respectively. Width to Spacing (s) ratios/W/S. In FIG. 8B, the traces are shown at 5 mils width.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily requite the particular order shown, or sequential order, to achieve desirable results. In some implementations, multitasking and parallel processing may be advantageous.

Having thus described the invention in rather full detail, it will be understood that such detail need not be strictly adhered to, but that additional changes and modifications may suggest themselves to one skilled in the art. For example, the high Q antenna may be fabricated in many shapes beyond those shown in FIG. 3 and may applied to insulating surfaces of various shapes. These and other modifications of the present invention are intended to fall within the scope of the invention as defined by the subjoined claims.

What is claimed is:

1) An inductive coil for a wireless system, comprising: two or more adjacent conductor traces arranged parallel to each other and electrically connected at proximal and distal ends; the two or more adjacent conductor traces being displaced from each other by a preselected fixed distance and being arranged in a single layer on one side of a substrate.

2) The inductive coil for a wireless system as recited by claim 1, wherein said substrate comprises a dielectric insulating circuit board.

3) The inductive coil for a wireless system as recited by claim 1, wherein the two or more adjacent conductor traces arranged parallel to each other have multiple bends to form a continuous single layer coil structure on a single plane of the substrate.

4) The inductive coil for a wireless system as recited by claim 1, wherein reciprocal of the ESR of the inductive coil is equal to the sum of reciprocal of the resistance of each of the two or more adjacent conductor traces arranged parallel to each other.

5) The inductive coil for a wireless system as recited by claim 1, wherein inductance of the inductive coil is proportional to the square of the number of adjacent conductor traces arranged parallel to each other.

6) The inductive coil for a wireless system as recited by claim 1, wherein quality factor of the inductive coil is equal to circular frequency times inductance divided by the ESR.

7) The inductive coil for a wireless system as recited by claim 1, wherein the two or more adjacent conductor traces arranged parallel to each other has eight times the quality factor of a single coil antenna.

8) The inductive coil for a wireless system as recited by claim 1, wherein there are three adjacent conductor traces arranged parallel to each other, and wherein the inductive coil has twenty seven times the quality factor of a single coil antenna.

9) The inductive coil for a wireless system as recited by claim 1, wherein the preselected fixed distance displacing the two or more adjacent conductor traces ranges from about 1.5 to 3 times the width of the two or more adjacent conductor traces.

10) The inductive coil for a wireless system as recited by claim 1, wherein the conductive coil is formed as a high Q adjacent printed antenna and is a component in a wireless charging system.

11) The inductive coil for a wireless system as recited by claim 1, wherein the substrate is a dielectric insulating circuit board formed as a polymeric sheet.

12) The inductive coil for a wireless system as recited by claim 1, wherein the inductive coil comprises a component in a system far wireless data transfer at frequencies covering and extending Wi-Fi and Wi-Max ranges.

13) The inductive coil for a wireless system as recited by claim 1, wherein the inductive coil comprises a communication component used in cable-modems, nodes, amplifiers or set-top boxes.

14) The inductive coil for a wireless system as recited by claim 1, wherein the substrate comprises a dielectric insulating circuit board with a bonded thin sheet of conductive metallic sheet etched to form the two or more adjacent conductor traces arranged parallel to each other.

15) The inductive coil for a wireless system as recited by claim 14, wherein the metallic foil is silver.

16) The inductive coil for a wireless system as recited by claim 14, wherein the metallic foil is gold.

17) The inductive coil for a wireless system as recited by claim 1, wherein the two or more adjacent conductor traces each have a trace width (W) ranging from 5 mils to 20 mils with a Width to Spacing (S) ratio preferable in the range of 0.33<W/S<2.5.

18) The inductive coil for a wireless system as recited by the claim 1, wherein the two or more adjacent conductor traces have a trace width ranging from 5 to 20 mils, and wherein said inductive coil has a Q factor ranging from 4.8 to 15.5.

19) The inductive coil for a wireless system as recited by the claim 1 comprising three adjacent conductor traces running in parallel, wherein each of said conductor traces have a trace width ranging from 5 to 20 mils, and wherein said inductive coil has a Q factor ranging from 14.4 to 46.65.

20) The inductive coil for a wireless system as recited by the claim 1 comprising four adjacent conductor traces running in parallel, wherein each of said conductor traces have a trace width ranging from 5 to 20 mils, and wherein said inductive coil has a Q factor ranging from 38.5 to 124.41.

21) The inductive coil for a wireless system as recited by claim 1, wherein the two or more adjacent conductor traces reduce the Effective Series Resistance (ESR) by a factor of an inverse of number of adjacent coils 1/N.

22) The inductive coil for a wireless system as recited by the claim 1 comprising an antenna dissipation power improved by a factor of an inverse of number of adjacent coils 1/N.

23) A method of manufacturing an inductive coil for a wireless system, comprising the steps of: selecting a substrate comprising an insulating dielectric board; applying and bonding electro deposited high purity electrodeposited thin copper foil; applying a photoresist and UV exposing the antenna pattern and hardening the photoresist; washing off the unexposed portion of photoresist, exposing copper surface; acid etching copper to create two or more adjacent conductor traces arranged parallel to each other, the two or more adjacent conductor traces being displaced from each other by a preselected fixed distance and being arranged in a single layer on one side of the substrate; connecting the two or more adjacent conductor traces at proximal and distal ends to an electrical connection pad; and protecting the surface of the two or more adjacent conductor traces with a polymeric protective coating; and whereby the two or more adjacent conductor traces have thickness determined by the thickness of the copper foil used and have a precise length and width and are spaced by designed dimension.
